(19) United States
(12) Patent Application Publication
(10) Pub. No.: US 2008/0106116 A1
(43) Pub. Date: May 8, 2008

(54) VEHICLE CONVERTIBLE TOP WITH AUTOMATIC CLOSING FEATURE

(76) Inventor: Charles Aaron Boulakia, Toronto (CA)

Correspondence Address: RIDOUT & MAYBEE;SUITE 2400, ONE QUEEN STREET EAST, TORONTO, ON, M5C3B1, CA

(21) Appl. No.: 11/934,432

(22) Filed: Nov. 2, 2007

Related U.S. Application Data
(60) Provisional application No. 60/864,220, filed on Nov. 3, 2006.

(51) Int. Cl. B60J 7/08; G05B 11/32

(52) U.S. Cl. 296/107.01; 296/216.01; 701/45

(57) ABSTRACT

Disclosed is a convertible top equipped with a rain sensor for automatically deploying (and closing) the convertible top when the car is parked with the top down and it starts to rain. Also disclosed is a sunroof with the same feature.

### BACKGROUND OF THE INVENTION

Vehicles with convertible tops are well known in the art, and have been an important part of automobile culture and invention since the dawn of automotive history. There are a wide variety of convertible tops available, with a wide variety of features.

Historically, convertible tops have comprised a movable frame covered with a flexible vinyl or cloth covering. The convertible tops were permanently affixed to the automobile frame in an area between the back seats of the automobile (or in the case of an automobile with no back seats, the front seats of the automobile) and the trunk of the automobile (or, in the case of an automobile with no trunk, the area behind the seats of the automobile), and removably affixed to the front of the automobile, typically to the top of the frame surrounding the windshield of the automobile.

When it was desired to lower the convertible top, a user would unlatch the top from the frame, then manually lower the top into a compartment located behind the seats. When it was desired to raise the top, the user would manually lift the top from the compartment behind the seats, then re-latch it to the frame. This system continues to exist today, for example, in the 2006 Mazda™ Miata™.

A convertible top that avoids the effort of manually raising or lowering the top has been known for some time. For example, in a 1971 Chevrolet™ Bonneville™, the top comprises a hydraulic system for displacing the top from an open position to a closed (but unlatched) position. When it was desired to lower the convertible top, a user would unlatch the top from the frame at the two corners of the interface between the frame and the top, then push a button on the dashboard. A hydraulic system would lower the top into the compartment located behind the seats. When the user desired to raise the top, the user would push and hold the button on the dashboard, which would activate the hydraulic system, displacing the top from the open (folded) position into the closed (unfolded) position. The user would then release the button on the dashboard and manually latch the top to the frame. This system continues to exist today in a wide variety of vehicles, for example, in the 2006 Chrysler™ PT Cruiser™, and the 2006 Ford™ Mustang™.

A further, more recent, improvement to the convertible top has been the advent of the automatically latching convertible top. In these tops, the step of having to manually latch or unlatch the top is automated. The user simply presses a button to both unlatch, and fold the top (i.e. to move the top from a closed, latched position to an open position). The user would press a button to reverse this operation. This system is a relatively new invention, and exists in a wide variety of vehicles, including the 2006 MINI™ Cooper™, the 2006 Lexus™ 430sc™, the Mercedes™ 230 Kompressor™ and the 2006 BMW™ 330csi™.

Some of these automobiles, such as the Lexus™ and the Mercedes™, have rigid convertible tops, made of aluminum, steel, fiberglass, or other materials such as carbon fiber. The principle of the opening and closing of the top is the same.

One of the problems with the current state of the art arises from user error. Users of convertibles have a tendency to leave the convertible top in the open position. Often, on a beautiful day, the user of a convertible will drive somewhere to do a “quick errand”, which turns into a longer time away from the car. The problem occurs when (inevitably) it starts to rain, and the interior of the automobile gets wet. Although the interiors are often designed to drain water away from them, many such automobiles have carpeted interiors, or cloth seats. Users thus often face long, wet car rides home. Wet interiors cause other problems as well, including the onset of mold, corrosion, and unnecessary wear to the inside of the vehicle.

A second problem with the current state of the art also arises from user error. Even when there is no rain, a closed top is better than an open top, when the car is left for long periods of time. For example, in a vinyl or cloth roof, an open top means a folded roof, which leads to creases and wear marks in the cloth or vinyl. An open top in the sun will lead to fading of dashboard and seats. An open top in a high risk area is more susceptible to crime.

Though there are some exceptions (the 2006 Porsche 911™), most convertible tops are only capable of opening or closing without damage when the car is stopped.

Moisture sensing devices are also well known. One type of moisture sensing device is utilized in alerting a person when a basement has been flooded. Other moisture sensing devices are utilized in a wide variety of situations where it is desired to alert a user when a surface becomes wet, or alternatively, when a surface becomes dry. Moisture sensors that can determine the difference between moisture in the air, and condensed moisture, are also well known in the art.

Rain sensors, which may be moisture sensors or may have another way of sensing rain, are also well known in the art. Rain sensors are utilized in some high-end automobiles, such as the Lexus™ 330SC, either to activate windshield wipers automatically upon activation (i.e. when rain is sensed) or to vary the speed of windshield wipers automatically depending on the amount of rain sensed, or both.

It would be desirable to have an automobile with a convertible roof that automatically closes when there is risk of the interior of the automobile becoming wet from rain when the automobile is not in use. It would also be desirable to have an automobile with a convertible roof that automatically closes after a certain amount of time, if the automobile is not in use.

### SUMMARY OF THE INVENTION

One embodiment of the present invention is an automatically closing convertible top for an automobile, comprising a convertible top, a convertible top motor, and a rain sensor, wherein the rain sensor activates the convertible top motor, closing the convertible top, when rain is sensed.

In one embodiment, the rain sensor only activates the convertible top motor when the automobile is not moving.

In a further embodiment of the present invention, the rain sensor only activates the convertible top motor when the ignition of the automobile is off.

In a further embodiment, the automatically closing convertible top further comprises a timer, wherein the timer automatically activates the convertible top motor, closing the convertible top, after a defined time period. For example, the defined time period may be about 2, 24 or 48 hours.

In a further embodiment of the present invention, the rain sensor is deactivated when the convertible top is in a closed position.

In a further embodiment of the present invention, the automatically closing convertible top further comprises a dedicated power supply. Such a dedicated power supply may provide sufficient power to operate the rain sensor for at least 48 hours and sufficient power to operate the convertible top motor to enable the closing of the convertible top at least two times.

In a further embodiment of the present invention, the automatically closing convertible top further comprises a power window controller and at least two power windows, wherein the rain sensor activates the power window controller, closing the power windows, when rain is sensed.

In a further embodiment, the automatically closing convertible top further comprises a motion sensor, wherein the motion sensor prevents the closing of the convertible top when motion is sensed.

In a further embodiment, the automatically closing convertible top further comprises a resistance sensor, wherein the resistance sensor prevents the closing of the convertible top when resistance is sensed on the convertible top.

Another aspect of the present invention is an automobile having the automatically closing convertible top as described herein.

Another aspect of the present invention is an automatically closing sunroof for an automobile, comprising a sunroof, a sunroof motor, and a rain sensor, wherein the rain sensor activates the sunroof motor, closing the sunroof, when rain is sensed.

In an further embodiment, the rain sensor only activates the sunroof motor when the automobile is not moving. In a further embodiment, the rain sensor only activates the sunroof motor when the ignition of the automobile is off.

In yet a further embodiment of the present invention, the automatically closing sunroof further comprises a timer, wherein the timer automatically activates the sunroof motor, closing the sunroof, after a defined time period. For example, the defined time period may be about 2, 24 or 48 hours.

In yet a further embodiment, the rain sensor is deactivated when the convertible top is in a closed position.

In a further embodiment, the automatically closing sunroof further comprises a dedicated power supply wherein the dedicated power supply provides sufficient power to operate the rain sensor for at least 48 hours and sufficient power to operate the sunroof motor to enable the closing of the sunroof at least two times.

In a further embodiment, the automatically closing sunroof further comprises a power window controller and at least two power windows, wherein the rain sensor activates the power window controller, closing the power windows, when rain is sensed.

In a further embodiment, the automatically closing sunroof further comprises a motion sensor, wherein the motion sensor prevents the closing of the sunroof when motion is sensed.

In a further embodiment, the automatically closing sunroof further comprises a resistance sensor, wherein the resistance sensor prevents the closing of the sunroof when resistance is sensed on the convertible top.

Another aspect of the present invention is an automobile having the sunroof as herein described.

Another aspect of the present invention is a kit for an automobile having a convertible top, said kit comprising a convertible top controller, and instructions for the installation of the convertible top controller, wherein, by following said instructions, a user is capable of installing said kit onto the automobile, converting said automobile into an automobile having the automatically closing convertible top as herein described. The kit may further comprise a rain sensor, a resistance sensor, and/or a motion sensor.

Another aspect of the present invention is a kit for an automobile having a sunroof, said kit comprising a sunroof controller, and instructions for the installation of the sunroof controller, wherein, by following said instructions, a user is capable of installing said kit onto the automobile, converting said automobile into an automobile having the automatically closing sunroof as herein described. The kit may further comprise a rain sensor, a resistance sensor, and/or a motion sensor.

Another aspect of the present invention is a kit for an automobile lacking a sunroof, said kit comprising a sunroof, a sunroof controller, and instructions for the installation of the sunroof and the sunroof controller, wherein, by following said instructions, a user is capable of installing said kit onto the automobile, converting said automobile into an automobile having the automatically closing sunroof as herein described. The kit may further comprise a rain sensor, a resistance sensor, and/or a motion sensor.

### BRIEF DESCRIPTION OF THE FIGURES

FIG. 1 is a schematic describing one embodiment of the present invention.

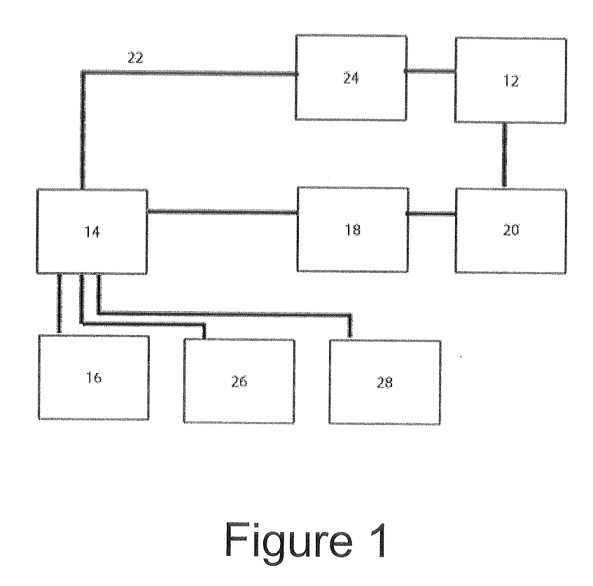

### DETAILED DESCRIPTION OF THE PREFERRED EMBODIMENT

A system for automatically closing a convertible top (12) when the interior of the automobile is at risk of becoming wet from rain or another source of moisture. The system comprises a rain sensor (14) or a moisture sensor (not shown), which is active or activatable while the automobile off i.e. when the automobile is parked, and the keys are out of the ignition (16).

In order to maximize battery efficiency, the rain sensor (14) or moisture sensor (not shown) is preferably only active when the convertible top (12) is in an “open” position. In order to have this feature, one component of the system (for example the convertible top operation module (18), the convertible top (12), the convertible top motor (20), the rain sensor (14), or, where it exists, the central computer (not shown) would “know” whether the convertible top is in an open or closed position. For example, there may be a circuit (22) running through the convertible roof latch (24), which is only complete when the latch (24) is engaged (i.e. the top (12) is closed). However, a person skilled in the art could contemplate a veritable cornucopia of different mechanisms and/or devices to provide this information.

Though the rain sensor (14) or moisture sensor is preferably active when the convertible top (12) is in an “open” position, it may be active all the time, when activated by a user, or when specifically not overridden by a user. For example, the rain sensor may, by default, activate automatically when the automobile is turned off (i.e. when the key is taken out of the ignition (16)), but there may be an override (26) feature, wherein the user may specifically deactivate the “automatic top closure” feature, for example, when the car is in a showroom or when it is otherwise desired to keep the top open. This override (26) may be in the form of a switch or button on the dashboard. The override (26) preferably resets when the ignition is engaged, thereby requiring the user to activate the override (26) every time the car is turned off and the user wishes the override (26) set.

Another example of the rain sensor (14) not being active all the time is where it is desired for the rain sensor to be deactivated automatically after a certain amount of time. Such automated deactivation may be desirable, for example, to conserve battery life when the automobile is unutilized for several days. Such automated deactivation can be (preferably) coupled with an automated closing of the convertible top (12). For example, the rain sensor (14) can be connected to a timer (30). The timer automatically deactivates the rain sensor (14) when the rain sensor (14) has been on for a specific or user controllable period of time with the automobile off—for example, when the automobile has been parked for greater than 48 hours. The timer may also activate the automatic closing of the top (12) at the same time. Alternatively, the timer may be set to automatically close the top (12) after a given amount of time (for example, 48 hours), such closing of the top automatically deactivating the rain sensor as described above.

Optionally, the rain sensor (12) and/or convertible top motor (20) may run off a power supply (not shown) that is different than the power supply used to start the car (for example, a starter battery (not shown), to minimize the risk of draining the starter battery.

To minimize cost, complexity, and parts, the rain sensor (14) or moisture sensor may be the same moisture sensor used to activate or control windshield wipers through the windshield wiper controller (28), though this is not essential.

In certain highly litigious or safety-conscious jurisdictions, it may be desirable to have a motion sensor (not shown) or a resistance sensor (not shown) that deactivates the closing of the top (12) when motion is sensed within the confines of the automobile, or when there is resistance to the closing of the top (for example, when an arm is placed between the top (12) and the top of the frame surrounding the windshield.

The system as herein described can also be utilized to close an automobile sunroof, or to close automobile windows, or both, in automobiles with a power sunroof or power windows, respectively, in a similar fashion.

I claim:

1. An automatically closing convertible top for an automobile, comprising:
(a) a convertible top;
(b) a convertible top motor;
(c) a rain sensor;
wherein the rain sensor activates the convertible top motor, closing the convertible top, when rain is sensed.

2. The automatically closing convertible top of claim 1 wherein the rain sensor only activates the convertible top motor when the ignition of the automobile is off.

3. The automatically closing convertible top of claim 1 further comprising a timer, wherein the timer automatically activates the convertible top motor, closing the convertible top, after a defined time period.

4. The automatically closing convertible top of claim 1 wherein the rain sensor is deactivated when the convertible top is in a closed position.

5. The automatically closing convertible top of claim 1 further comprising a dedicated power supply wherein the dedicated power supply provides sufficient power to operate the rain sensor for at least 48 hours and sufficient power to operate the convertible top motor to enable the closing of the convertible top at least two times.

6. The automatically closing convertible top of claim 1 further comprising a power window controller and at least two power windows, wherein the rain sensor activates the power window controller, closing the power windows, when rain is sensed.

7. The automatically closing convertible top of claim 1, further comprising a motion sensor, wherein the motion sensor prevents the closing of the convertible top when motion is sensed.

8. The automatically closing convertible top of claim 1, further comprising a resistance sensor, wherein the resistance sensor prevents the closing of the convertible top when resistance is sensed on the convertible top.

9. An automobile having the automatically closing convertible top of claim 1.

10. An automatically closing sunroof for an automobile, comprising:
(d) a sunroof;
(e) a sunroof motor,
(f) a rain sensor;
wherein the rain sensor activates the sunroof motor, closing the sunroof, when rain is sensed.

11. The automatically closing sunroof of claim 10 wherein the rain sensor only activates the sunroof motor when the ignition of the automobile is off.

12. The automatically closing sunroof of claim 10 further comprising a timer, wherein the timer automatically activates the sunroof motor, closing the sunroofs after a defined time period.

13. The automatically closing sunroof of claim 10 wherein the rain sensor is deactivated when the sunroof is in a closed position.

14. The automatically closing sunroof of claim 10 further comprising a dedicated power supply wherein the dedicated power supply provides sufficient power to operate the rain sensor for at least 48 hours and sufficient power to operate the sunroof motor to enable the closing of the sunroof at least two times.

15. The automatically closing sunroof of claim 10 further comprising a power window controller and at least two power windows, wherein the rain sensor activates the power window controller, closing the power windows, when rain is sensed.

16. The automatically closing sunroof of claim 10, further comprising a motion sensor, wherein the motion sensor prevents the closing of the sunroof when motion is sensed.

17. The automatically closing sunroof of claim 10, further comprising a resistance sensor, wherein the resistance sensor prevents the closing of the sunroof when resistance is sensed on the convertible top.

18. An automobile having the sunroof of claim 10.

19. A kit for an automobile having a convertible top, said kit comprising:
(a) a convertible top controller;
(b) instructions for the installation of the convertible top controller;
wherein, by following said instructions, a user is capable of installing said kit onto the automobile, converting said automobile into an automobile having the convertible top of claim 1.

20. A kit for an automobile having a sunroof, said kit comprising:
(c) a sunroof controller;
(d) instructions for the installation of the sunroof controller;
wherein, by following said instructions, a user is capable of installing said kit onto the automobile, converting said automobile into an automobile having the sunroof of any one of claims 10.

21. A kit for an automobile lacking a sunroof said kit comprising:
(e) a sunroof;
(f) a sunroof controller,
(g) instructions for the installation of the sunroof and the sunroof controller;
wherein, by following said instructions, a user is capable of installing said kit onto the automobile, converting said automobile into an automobile having the sunroof of any one of claims 10.
